(19) United States
(12) Patent Application Publication
(10) Pub. No.: US 2014/0297709 A1
(43) Pub. Date: Oct. 2, 2014

(54) METHOD AND MOBILE TERMINAL FOR CREATING A CONTACT

(71) Applicant: Xiaomi Inc., Beijing (CN)

(72) Inventors: Xinyu Liu, Beijing (CN); Kun Niu, Beijing (CN); Zhongliang Qiao, Beijing (CN); Xiehao Bao, Beijing (CN)

(73) Assignee: Xiaomi Inc., Beijing (CN)

(21) Appl. No.: 14/092,854

(22) Filed: Nov. 27, 2013

Related U.S. Application Data
(63) Continuation-in-part of application No. PCT/CN2013/083495, filed on Sep. 13, 2013.

(30) Foreign Application Priority Data
Mar. 27, 2013 (CN) 201310102476.1

(51) Int. Cl. H04L 29/08

(52) U.S. Cl. CPC H04L 67/306
USPC 709/201

(57) ABSTRACT

The present disclosure discloses a method for creating a contact in a mobile terminal and the mobile terminal thereof. The method comprises: receiving a request for creating the contact; obtaining at least one piece of environmental information; and generating contact information of the contact comprising the obtained environmental information, wherein the environmental information is configured to identify environment during the creation of the contact. According to the present disclosure, many pieces of information may be obtained by obtaining at least one piece of environmental information while creating a contact without any manual input performed by the user, thereby simplifying operation of the user and facilitating contacts management in the mobile terminal.

### CROSS-REFERENCE TO RELATED APPLICATIONS

This application is a Continuation-In-Part of International Application PCT/CN2013/083495, with an international filing date of Sep. 13, 2013, which claims priority to Chinese Patent Application No. 201310102476.1, filed on Mar.27, 2013, both of which are hereby incorporated by reference in their entireties.

### TECHNICAL FIELD

The present disclosure generally relates to terminal technology, and more particularly, to a method for creating a contact in a mobile terminal and the mobile terminal thereof.

### BACKGROUND

With the development of terminal technology, a mobile terminal is provided with more and more functions. Among various functions of the mobile terminal, communication with a contact is the most basic and essential function of the mobile terminal. A user may create a contact by editing information in the contacts of a mobile terminal. When the user desires to get in touch with a contact, a user may browse names of all the contacts in the mobile terminal to find the corresponding telephone number of the contact, thereby to call, message the contact and so forth.

Information of multiple contacts may be stored in the mobile terminal. A user needs to edit manually upon creating a contact, and it is necessary for a user to manually input multiple information to the mobile terminal so as to attain detailed information on the contact. This process may take a relatively long time, which complicates the user's operation, and is not in conformity with the user's habit. Therefore, the user, generally, elects to edit certain basic information of a contact such as name and telephone number thereof.

Consequently, the mobile terminal can only supply the user with limited information on contacts, which may cause the user to fail to remember the contacts or some related information. Such cases may count against the management of contacts in the mobile terminal.

### SUMMARY

The above deficiencies and other problems associated with contacts management are reduced or eliminated by the present disclosure.

According to one aspect of embodiments of the present disclosure, a method for creating a contact in a mobile terminal comprises: receiving a request for creating the contact; obtaining at least one piece of environmental information; and generating contact information of the contact comprising the obtained environmental information, wherein the environmental information is configured to identify environment during the creation of the contact.

Preferably, the method further comprises: receiving at least one piece of information inputted by a user prior to generating the contact information, and wherein generating comprises: generating the contact information comprising the information inputted by the user and the obtained environmental information.

Preferably, the information inputted by the user is selected from a group consisting of a nickname, an introducer, and other descriptive information of the contact.

Preferably, obtaining comprises at least one of: obtaining a contact creation time; obtaining geographical location information of the mobile terminal; obtaining audio information comprising a voice sample of the contact; and obtaining image information comprising at least one of photos of the surrounding environment.

Preferably, the geographical location information comprises at least one map with a pinpoint indicating a current geographical location.

Preferably, after obtaining the geographical location information, the method further comprises: obtaining weather information corresponding to an area indicated by the obtained geographical location information.

Preferably, obtaining the weather information comprises: determining the area indicated by the obtained geographical location information and obtaining the weather information corresponding to the area with a weather information application; or determining the area indicated by the obtained geographical location information and obtaining the weather information corresponding to the area by performing a search using name of the area as a keyword.

Preferably, after obtaining the audio information, the method further comprises: collecting a voice sample of a contact at opposite end during a communication when receiving a voice recognition command; recognizing the voice sample of the contact at opposite end according to the obtained voice samples of contacts; and if the obtained voice samples of the contacts comprise a voice sample matching with the voice sample of the contact at opposite end, obtaining contact information corresponding to the matched voice sample.

According to another aspect of embodiments of the present disclosure, a mobile terminal for creating a contact comprises one or more processors; and a memory configured to store one or more programs for execution by the one or more processors; wherein the one or more programs include instruction for: receiving a request for creating the contact; obtaining at least one piece of environmental information; and generating contact information of the contact comprising the obtained environmental information, wherein the environmental information is configured to identify environment during the creation of the contact.

According to another aspect of embodiments of the present disclosure, a nonvolatile computer readable storage medium store one ore more programs, which when executed perform a method in a mobile terminal, the method comprising: receiving a request for creating the contact; obtaining at least one piece of environmental information; and generating contact information of the contact comprising the obtained environmental information, wherein the environmental information is configured to identify environment during the creation of the contact.

It should be understood that the above general description and the detailed description hereinafter are only illustrative but not to limit the present disclosure.

The technical solutions of the embodiments according to the present disclosure, in part, can be provided with the following advantages. By employing the technical solution of the present disclosure, many pieces of information may be obtained by obtaining at least one piece of environmental information while creating a contact without any manual input performed by the user, thereby simplifying operations performed by the user, and facilitating contacts management in the mobile terminal.

### BRIEF DESCRIPTION OF THE DRAWINGS

In order to illustrate the technical solution in the embodiments of the present disclosure, the accompanying drawings used in describing the embodiments are simply illustrated as follows. Obviously, the following drawings are only a way of example to describe the present disclosure, and those skilled in the art can obtain other drawings accordingly without making any inventive effort.

FIG. 1 is a schematic flow chart illustrating a method for creating a contact according to an embodiment of the present disclosure.

FIG. 2 is a schematic flow chart illustrating a method for creating a contact according to another embodiment of the present disclosure.

FIG. 3 is an illustrative diagram showing a display of contact information according to an embodiment of the present disclosure.

FIG. 4 is an illustrative block diagram showing a device for creating a contact according to an embodiment of the present disclosure.

Specific embodiments in this present disclosure have been shown by way of example in the foregoing drawings and are hereinafter described in detail. The drawings and written description are not intended to limit the scope of the inventive concepts in any manner. Rather, they are provided to illustrate the inventive concepts to a person skilled in the art by reference to particular embodiments.

### DETAILED DESCRIPTION

With reference to the accompanying drawings, the technical solution of the present disclosure will be described hereinafter clearly and completely in the embodiments of the present disclosure. Obviously, the described embodiments are only a part of the embodiments covered by the present disclosure. All other embodiments obtained by those skilled in the art without making any inventive effort based on the embodiments of the present disclosure will fall within the protection scope of the present disclosure.

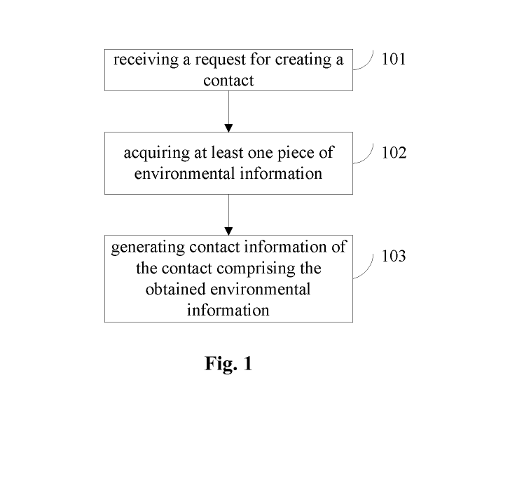

FIG. 1 is a flow chart of a method for creating a contact according to an embodiment of the present disclosure. This embodiment of the present disclosure may be implemented by a mobile terminal. Referring to FIG. 1, the method comprises the steps described below.

In step 101, the mobile terminal receives a request for creating a contact. An option for creating a contact is provided in the mobile terminal. When it is required to create a new contact in the mobile terminal, a user may click the option to trigger the request for creating the contact by using a display screen or an input module configured in the mobile terminal.

In step 102, the mobile terminal obtains at least one piece of environmental information configured to identify environment during the creation of the contact. Upon receiving the request for creating contacts from the user, the mobile terminal may initiate a step or procedure to obtain one or more pieces of environmental information automatically. Herein, the environmental information may comprise at least one of time information, location information, audio information, image information, and so forth. The environmental information is configured to show what the environment or surrounding is when the contact is created.

In step 103, the mobile terminal generates contact information of the contact comprising the obtained environmental information. According to the one or more pieces of environmental information obtained, the contact information on the contact may be generated. When the user needs to browse the contact information, at least one or more pieces of the environmental information may be presented to the user in corresponding manners, for example, a head portrait of the contact may be presented to the user in the form of picture.

By employing the technical solution of the present disclosure, many pieces of information may be obtained by obtaining at least one piece of environmental information while creating a contact without any manual input by the user, thereby simplifying the operations performed by a user, and facilitating contacts management in the mobile terminal.

Preferably, prior to generating the contact information of the contact, the method further comprises: receiving at least one piece of information inputted by a user. Correspondingly, the step of generating the contact information comprises: generating the contact information comprising the information inputted by the user and the obtained environmental information.

Preferably, the information inputted by the user is selected from a group consisting of a nickname, an introducer, and other descriptive information of the contact.

Preferably, the step of obtaining at least one piece of environmental information may comprise: obtaining a contact creation time. In some embodiments, the contact creation time is present time indicated by a clock configured in the mobile terminal. In other embodiments, the contact creation time may be obtained by using a time adjustment service provided by a network.

Preferably, the step of obtaining at least one piece of environmental information may comprise: obtaining geographical location information of the mobile terminal. In some embodiments, the geographical location information is obtained by performing positioning based on Global Position System (GPS) or a positioning service provided by one or more base stations.

Preferably, the step of obtaining at least one piece of environmental information may comprise: obtaining audio information comprising voice samples of the contact. In some embodiments, the audio information also includes sound of the surrounding environment. Preferably, the audio information is obtained by recording via a microphone or other recoding modules configured in the mobile terminal.

Preferably, the step of obtaining at least one piece of environmental information may comprise: obtaining image information comprising at least one of photos of the surrounding environment. In some embodiments, the image information may also include at least one of photos of the contact person. The image information may be obtained by shooting the surrounding environment and/or the contact person via an image capturing device configured in the mobile terminal.

Preferably, the geographical location information of the mobile terminal comprises at least a map with a pinpoint or mark of the current geographical location. Preferably, after performing the GPS positioning so as to obtain the geographical location of the mobile terminal, the method further comprises: obtaining weather information corresponding to an area indicated by the obtained geographical location information. According to the obtained geographical location information, the mobile terminal may decide the area corresponding to the obtained geographical location information and then obtain weather information of the area.

Preferably, obtaining weather information corresponding to the area indicated by the obtained geographical location information comprises: determining the area indicated by the obtained geographical location information of the mobile terminal, and obtaining the weather information corresponding to the area with a weather information application installed in the mobile terminal.

Preferably, obtaining weather information corresponding to the area indicated by the obtained geographical location information comprises: determining the area indicated by the obtained geographical location information of the mobile terminal, and obtaining the weather information corresponding to the area by performing a search using name of the area as a keyword.

Preferably, after recording via the microphone configured in the mobile terminal so as to obtain the audio information, the method further comprises: collecting a voice sample of a contact at the opposite end during a communication when receiving a voice recognition recording command; recognizing the voice sample of the contact at the opposite end according to the obtained voice samples; and if it is determined that the obtained voice sample of the contacts comprises a voice matching the voice of the contact at the opposite end, then obtain the contact information of the contact corresponding to the matching voice sample.

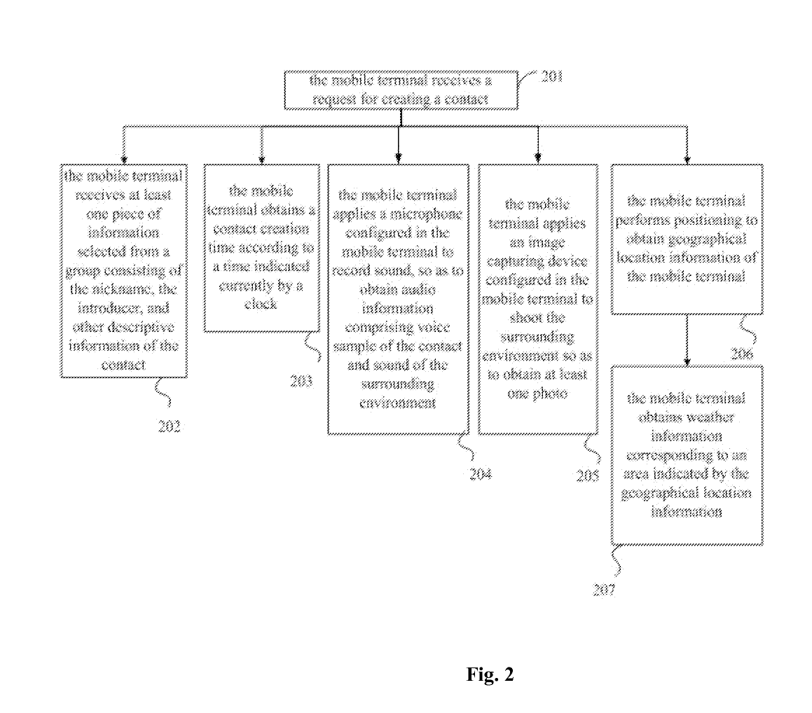

FIG. 2 is a flow chart of a method for creating a contact according to another embodiment of the present disclosure. This embodiment of the present disclosure may be implemented by a mobile terminal. Referring to FIG. 2, the method comprises the steps described below.

In step 201, the mobile terminal receives a request for creating a contact. In step 202, the mobile terminal receives at least one piece of information selected from a group consisting of the nickname, the introducer, and other descriptive information of the contact, which are inputted by a user.

Preferably, the at least one piece of the information inputted by the user may comprise a name, a telephone number, an Email address of the contact, and so on.

In the embodiment of the present disclosure, when the mobile terminal receives a request for creating a contact, an interface for creating the contact is displayed on a display screen. The interface is provided thereon with various options, such as the telephone number and the correspondence address. Further, the interface is also provided with the nickname, the introducer, or other descriptive information of the contact. When the user inputs at least one piece of information of the contact, the mobile terminal buffers the input information.

Preferably, the descriptive information on the contact may comprise the contact's employment, career positions, first impression by the user, and so on.

In the embodiment of the present disclosure, a skilled person may set the options on the interface during the development of the interface, or allow the user to add or delete options during operations. It is not limited in details by the embodiments of the present disclosure.

The difference between the present disclosure and the conventional method for creating a contact lies in that the mobile terminal of the present disclosure provides multiple-dimensional editable options, such as nickname, introducer, and career position of the contact, which allows a user to input more corresponding information rather than some basic information, such as name and telephone number of the contact. Therefore, the user can easily remember a contact by looking over the detailed information on the contact when he/she forgets the contact, which facilitates the management of contacts.

It should be noted that step 202 is an optional step. If by default the mobile terminal provides an input box(s) for nickname, introducer, or other descriptive information of the contact, the input box may be directly displayed while the interface for creating a contact is displayed. However, if they are optional items provided to the user by the mobile terminal, the items may be displayed in a menu for creating the contact. That is, when a command for activating the menu is received, an option(s) corresponding to nickname, introducer, or other descriptive information on the contact may be displayed in the menu and triggered by the user so as to input or amend the corresponding information. Moreover, an option of “add detailed information” may be directly displayed while an interface for creating a contact is displayed. When a command for adding detailed information is received, an input box is directly displayed on the interface, and information such as “introducer-Zhang San” may be input by a user to the input box. In addition, the information on the contact such as name, telephone number, employment, and position may be obtained by directly shooting a business card of the contact and without the user to input the required one or more information of the contact. It is not limited in details by the embodiment of the present disclosure.

Preferably, when a mobile terminal receives a request for creating a contact, the one or more pieces of environmental information required to be obtained is determined according to a list of environmental information provided by the mobile terminal. The list of environmental information may include types of environmental information built in the mobile terminal or preset by a user of the mobile terminal. The list of environment information is predetermined by the mobile terminal and is used to determine what type of environmental information needed to be inputted as environment information of the contact. If the list of environmental information merely includes types of geographical location information, the mobile terminal may only need to obtain the geographical location information as the environment information of the contact. In this case, the mobile terminal may automatically start up GPS positioning while receiving a request for creating a contact, so as to obtain current geographical location information of the mobile terminal, which may be stored in a database of the mobile terminal. If the list of environmental information further includes other types of environmental information, other corresponding information may be obtained as the environment information of the contact and stored in the database of the mobile terminal. For example, the mobile terminal may further obtain a social network record of the contact according to information such as position and introducer input by the user and the contact information stored in the mobile terminal.

In the embodiment of the present disclosure, the list of environmental information, including contact creation time, audio information, image information, geographical location information and weather information, is only taken as an example to illustrate the present disclosure. However, in other embodiments, the list of environmental information may include other types of environmental information, and is not limited to the details herein.

In step 203, the mobile terminal obtains a contact creation time according to a time currently indicated by a clock. Preferably, the mobile terminal obtains the contact creation time according to the time currently indicated by the clock while receiving the request for creating a contact, so as to facilitate a user from checking the specific creation time of the contact or grouping contacts created during the same time period.

It should be noted that step 203 is an optional step. If the mobile terminal obtains a contact creation time by default, the contact creation time may be obtained directly while the interface for creating a contact is displayed. Otherwise, if it is an optional item provided to a user by the mobile terminal, an option for obtaining a creation time may be displayed in a menu for creating the contact, and the user may choose this option to obtain the contact creation time.

In step 204, the mobile terminal applies the microphone configured in the mobile terminal to record sound, so as to obtain audio information comprising voice sample of the contact and sound of the surrounding environment.

The microphone configured in the mobile terminal may record sound while receiving a request for creating a contact. During the recordation of sound, the information such as conservation between the user and the contact and sound of the surrounding environment may be recorded. That is, the obtained audio information may include voice sample of the contact and sound of the surrounding environment, which includes the voice sample of the user. According to the conservation record contained in the audio information, the user may obtain information such as employment and job position of the contact. According to the voice sample of the contact, sound characteristics of the contact may be recorded so as to facilitate recognition of the contact in subsequent communications.

Those skilled in the art may know that, after audio information is obtained, voice sample of the contact may be extracted by voice recognition programs, and the contact may be recognized according to the obtained voice sample of the contact since the sound characteristics of the contact may not change.

The recording process may be executed accompanying the operation of inputting information or other operations performed by a user during the process of creating a contact.

In the embodiment of the present disclosure, the recording may be performed according to the preset recording duration. When the recording time exceeds the preset recording duration, the recording may be stopped. It is not limited in details by the embodiment of the present disclosure.

It should be noted that step 204 is an optional step. If the mobile terminal performs a recording by default, the mobile terminal may turn on the microphone to record while displaying the interface for creating a contact. Otherwise, if it is an optional item provided to a user by the mobile terminal, an option for obtaining audio information may be displayed in a menu for creating the contact and the user may choose this option to trigger a command for activating the recording, and the mobile terminal may turn on the microphone to obtain the acoustic information after receiving the command.

In step 205, the mobile terminal applies an image capturing device configured in the mobile terminal for shooting the surrounding environment so as to obtain at least one photo of the surrounding environment.

Upon receiving a request for creating a contact, the mobile terminal may turn on an image capturing device such as a camera configured in the mobile terminal to shoot the surrounding environment to obtain at least one picture. The obtained one picture or more may include a head portrait of the contact, an image of the geographical location at which the contact is created, or the like. By looking over the obtained picture, the user may recall spontaneously the scene in which the contact was created.

In the embodiment of the present disclosure, the image capture device may be turned on accompanying the operation of inputting information or other operations performed by a user during the process of creating a contact. The mobile terminal may capture pictures automatically according to a predetermined number of shots, or the user may be prompted to hold the mobile terminal to manually capture a predetermined number of pictures. It is not limited in details by the embodiment of the present disclosure. Preferably, at least one picture may be captured mutely.

It should be noted that step 205 is an optional step. If the mobile terminal captures a picture by default, the mobile terminal may turn on the image capturing device to capture picture while displaying the interface for creating a contact. Otherwise, if it is an optional item provided to a user by the mobile terminal, an option of capturing a picture may be displayed in a menu for creating the contact and the user may choose this option to obtain at least one picture.

In step 206, the mobile terminal performs positioning by using a Global Position System (GPS) positioning service or a positioning service provided by one or more base stations, so as to obtain geographical location information of the mobile terminal. The positioning service provided by one or more base stations may include a location-based service (LBS).

For example, upon receiving a request for creating a contact, the mobile terminal may turn on the GPS positioning or the LBS positioning configured in the mobile terminal, so as to obtain and record coordinates in latitude and longitude of current geographical location of the mobile terminal. Furthermore, the mobile terminal may mark the current geographical location on a third-party map, so as to obtain a map with such a pinpoint and mark of the current geographical location.

The geographical location information may comprise information such as a map and coordinates in latitude and longitude. When a user checks the geographical location information, the text information in the geographical location information may be presented to the user, and then the map with the mark of the current geographical location may be triggered and presented to the user.

It should be noted that step 206 is an optional step. If the mobile terminal has obtained the geographical location information by default, the mobile terminal may directly use the geographical location information obtained by default while displaying an interface for creating a contact. However, if it is an optional item provided to a user by the mobile terminal, an option of obtaining geographical location information may be displayed in a menu for creating the contact and the user may choose this option to obtain the geographical location information.

In step 207, the mobile terminal obtains weather information corresponding to an area indicated by the obtained geographical location information.

After the geographical location information of the mobile terminal is obtained, the weather information corresponding to the area indicated by the geographical location information may be obtained according to the geographical location information.

The weather information may comprise weather forecast such as a sunny day or a rainy day, and may also comprise air temperature. It is not limited in details by the embodiment of the present disclosure.

Preferably, step 207 may comprise step A. In step A, the mobile terminal determines an area indicated by the geographical location information of the mobile terminal, and obtains the weather information corresponding to the determined area with a weather information application installed in the mobile terminal.

For example, the mobile terminal may obtain weather information corresponding to each respective area of a plurality of areas according to the installed weather information application. Upon obtaining the geographical location information, the mobile terminal may determine the area at which the mobile terminal is located. Furthermore, the mobile terminal may obtain the weather information corresponding to the determined area from the plurality of obtained weather information corresponding to a plurality of areas.

Alternatively, step 207 may comprise step B. In step B, the mobile terminal determines an area indicated by the obtained geographical location information of the mobile terminal, and obtains the weather information corresponding to the determined area by performing a search using name of the area as a keyword according to the area.

For example, upon obtaining the geographical location information, the mobile terminal may determine the area indicated by the obtained geographical location information, and obtains the weather information corresponding to the determined area at which the mobile terminal is located by searching over the Internet using name of the determined area as a keyword.

It should be noted that step 207 is an optional step. If the mobile terminal is configured to obtain weather information by default while obtaining the geographical location information, the mobile terminal may obtain the weather information without any instructions of user, upon obtaining the geographical location information while displaying an interface for creating a contact. However, if it is an optional item provided to a user by the mobile terminal, an option of obtaining weather information may be displayed in a menu for creating the contact and the user may choose this option to obtain the weather information.

It should be noted that steps 203-207 may be performed by the mobile terminal automatically, or may be performed after being triggered by a user. Preferably, step 207 is required to be performed after step 206, while there are no sequential relationships among the other steps. For example, upon receiving a request for creating a contact, the mobile terminal may select any one or more steps from steps 203-207 to obtain information on the contact, and the triggered steps may be performed simultaneously, or may be performed sequentially as long as step 207 is performed after step 206. It is not limited in details by the embodiment of the present disclosure.

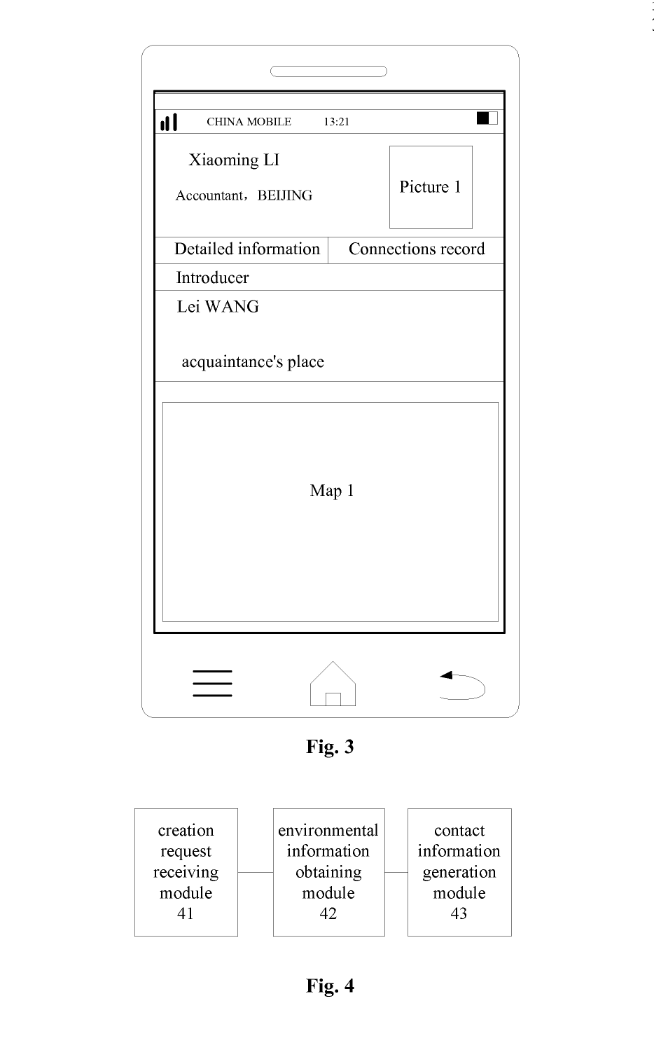

FIG. 3 is a schematic diagram showing a display of contact information according to an embodiment of the present disclosure. Referring to FIG. 3, if the user checks the information on a contact “Xiaoming Li”, the basic information on “Xiaoming Li”, such as job position “accountant”, residency “Beijing”, head portrait “picture 1”, and introducer “Lei Wang”, may be displayed on a display screen of a mobile terminal. A location where the contact “Xiaoming Li” is created may be displayed as map 1, which includes a geographical location where the contact “Xiaoming Li” is created and surrounding areas.

Base on the example in FIG. 3, when a user clicks the “detailed information” button, the contact information such as the contact creation time, audio information, weather information are displayed on a display screen of the mobile terminal for the user to view. When a user clicks the “connection record” button, the connection record of Xiaoming Li is displayed.

Further, after the process of creating a contact is completed, the method further comprises steps 208, 209, and 210.

In step 208, when a voice recognition command is received, audio information of a contact at the opposite end (partner) during a communication is collected.

During the communication with a contact in the manners such as conversation or voice message, and when the user can't recognize the contact at the opposite end, for example, the telephone number of the contact was not stored, audio information of the contact at opposite end may be recorded by triggering a voice recognition command.

In step 209, the audio information of the contact at opposite end is recognized according to the stored voice examples of contacts.

It is known from step 204 that the mobile terminal obtains a voice sample of a contact while creating the contact, and thus the voice samples of each respective contact persons are stored in the mobile terminal. The audio information of the contact at the opposite end may be recognized according to the stored voice samples of the contacts, and it is determined by whether the stored voice sample of the contacts matches the voice of the contact at the opposite end.

In step 210, if it is determined that the stored contact information of the contacts comprises audio information matching the voice sample of the contact at opposite end, the contact information corresponding to the matched audio information may be obtained.

When a contact changes his/her telephone number, a user may quickly obtain information on the contact and identify the contact by recognizing the audio information of the contact with an unknown telephone number.

FIG. 4 is an illustrative block diagram showing a device for creating a contact according to an embodiment of the present disclosure. Referring to FIG. 4, the device comprises: a creation request receiving module 41 configured to receive a request for creating the contact; an environmental information obtaining module 42 configured to obtain at least one piece of environmental information during the creation of the contact; and a contact information generation module 43 configured to generate contact information on a contact including the one or more pieces of environmental information obtained. The environmental information is configured to identify environment during the creation of the contact.

Preferably, the device further comprises: an information receiving module configured to receive at least one piece of information inputted by a user. Correspondingly, the contact information generation module 43 comprises: a first information generation unit configured to generate the contact information comprising the information inputted by the user and the obtained environmental information obtained.

Preferably, the information receiving module comprises: an information receiving unit configured to receive at least one piece of information selected from the nickname, the introducer and other descriptive information of the contact, which are input by the user.

Preferably, the environmental information obtaining module 42 comprises at least one of: a creation time obtaining unit configured to obtain a contact creation time according to the present time indicated by a clock of the mobile terminal; a location information obtaining unit configured to perform a Global Position System (GPS) positioning or a positioning service provided by one or more base stations so as to obtain geographical location information of the mobile terminal; an audio information obtaining unit configured to record via the microphone configured in the mobile terminal so as to obtain audio information comprising a voice sample of the contact and sound of the surrounding environment; and an image obtaining unit configured to shoot the surrounding environment via an image capturing device configured in the mobile terminal so as to obtain at least one photo of the surrounding environment.

Preferably, the geographical location information includes at least a map with a pinpoint or mark of the current geographical location.

Preferably, the device further comprises: a weather information obtaining unit configured to obtain weather information corresponding to an area indicated by the obtained geographical location information.

Preferably, the weather information obtaining unit comprises: a first obtaining sub-unit configured to determine the area at which the mobile terminal is located according to the obtained geographical location information, and obtaining the weather information corresponding to that area with a weather information application installed in the mobile terminal.

Alternatively, the weather information obtaining unit comprises a second obtaining sub-unit configured to determine the area at which the mobile terminal is located according to the obtained geographical location information, and to obtain the weather information corresponding to the area by performing a search using name of the area as a keyword.

Preferably, the device further comprises: an audio information obtaining module configured to obtain audio information of a contact at the opposite end during a communication when receiving a voice recognition command, a recognition module configured to recognize the voice of the contact at the opposite end according to the stored voice samples of the contacts; and an information matching module configured to obtain a contact information corresponding to the matched voice sample, if it is determined that the stored voice samples of the contacts comprises a voice sample matching with the voice of the contact at the opposite end.

It should be noted that the device for creating a contact according to the above embodiments is divided into the above function modules for the purpose of an example. However, in practical application, the above functions may be implemented by different function modules as needed, that is, the internal structure of the mobile terminal may be divided into different function modules to achieve all or a part of the functions described above. In addition, the device for creating a contact has the same concept as the method for creating a contact, and thus the specific implementation process thereof may refer to the embodiment of the method and will be omitted herein.

The methods for creating contacts according to embodiments of the present disclosure are implemented by the mobile terminal. In practical applications, the mobile terminal may include mobile phones, computers, digital broadcast terminals, messaging devices, gaming consoles, tablets, PDAs, medical devices, exercise equipment, personal digital assistants, and the like.

The mobile terminal includes one or more processors, such as a computer processor or microprocessor as known in the industry to receive various data, programs and instructions, and to process such data, programs and instructions accordingly. The one or more processors may obtain at least one piece of environmental information and generate contact information of the contact comprising the obtained environmental information in response to receiving a request for creating the contact.

The mobile terminal may also include a memory which is coupled to the one or more processors and is configured to store the data, programs and instructions to be processed by the processors. The memory may store the obtained environment information and the generated contact information of the contacts.

Furthermore, the mobile terminal may further include input modules, such as a touch screen, a keyboard, a mouse or the like to receive requests and inputs from the user. The mobile terminal may further include a clock for providing timing information to indicate present time of the mobile terminal. Preferably, the mobile terminal may further include an image capturing module, such as a camera to take photos. Moreover, the mobile terminal may further include a recording module, such as a microphone to record audio information. Additional circuitry, including a combination of hardware circuitry and software, are, of course, included to obtain the needed functionality described therein. These are not described in details as they would be readily apparent to those skilled in the art.

Those skilled in the art may appreciate that all or a part of steps in the above embodiments may be implemented by a hardware or may be implemented in a related hardware instructed by a program stored in a nonvolatile computer readable storage medium. The computer can also include the mobile terminal as defined in the present disclosure.

The nonvolatile computer readable storage medium may use, for example, computer software, hardware, or some combination thereof. For a hardware implementation, the embodiments described herein may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a selective combination thereof.

For a software implementation, the embodiments described herein may be implemented with separate software modules, such as procedures and functions, each of which perform one or more of the functions and operations described herein. The software codes can be implemented with a software application written in any suitable programming language and may be stored in memory of the terminal.

The aforementioned methods can be implemented in a nonvolatile computer readable storage medium recording computer-readable codes. The nonvolatile computer readable storage medium includes all kinds of recording devices in which data readable by a computer system are stored. The nonvolatile computer readable storage medium includes ROM, RAM, CD-ROM, magnetic tapes, floppy discs, optical data storage devices, and the like, as well as carrier-wave type implementations (e.g., transmission via Internet).

The embodiments described above are illustrated as preferred embodiments of the present disclosure but not to limit the present disclosure. All modifications, equivalent substitutions, and improvements which are made within sprits and principles of the present disclosure shall fall within the protection scope of the present disclosure.

What is claimed is:

1. A method for creating a contact in a mobile terminal, comprising:
receiving a request for creating the contact;
obtaining at least one piece of environmental information; and
generating contact information of the contact comprising the obtained environmental information,
wherein the environmental information is configured to identify environment during the creation of the contact.

2. The method of claim 1, further comprising: receiving at least one piece of information inputted by a user prior to generating the contact information,
wherein generating comprises: generating the contact information comprising the information inputted by the user and the obtained environmental information.

3. The method of claim 2, wherein the information inputted by the user is selected from a group consisting of a nickname, an introducer, and other descriptive information of the contact.

4. The method of claim 1, wherein obtaining comprises at least one of:
obtaining a contact creation time;
obtaining geographical location information of the mobile terminal;
obtaining audio information comprising a voice sample of the contact; and
obtaining image information comprising at least one of photos of the surrounding environment.

5. The method of claim 4, wherein the geographical location information comprises at least one map with a pinpoint indicating a current geographical location.

6. The method of claim 4, wherein, after obtaining the geographical location information, the method further comprises:
obtaining weather information corresponding to an area indicated by the obtained geographical location information.

7. The method of claim 6, wherein obtaining the weather information comprises:
determining the area indicated by the obtained geographical location information and obtaining the weather information corresponding to the area with a weather information application; or
determining the area indicated by the obtained geographical location information and obtaining the weather information corresponding to the area by performing a search using name of the area as a keyword.

8. The method of claim 4, after obtaining the audio information, the method further comprises:
collecting a voice sample of a contact at opposite end during a communication when receiving a voice recognition command;
recognizing the voice sample of the contact at opposite end according to the obtained voice samples of contacts; and
if the obtained voice samples of the contacts comprise a voice sample matching with the voice sample of the contact at opposite end, obtaining contact information corresponding to the matched voice sample.

9. A mobile terminal for creating a contact, comprising:
one or more processors; and
a memory configured to store one or more programs for execution by the one or more processors;
wherein the one or more programs include instruction for:
receiving a request for creating the contact;
obtaining at least one piece of environmental information; and
generating contact information of the contact comprising the obtained environmental information,
wherein the environmental information is configured to identify environment during the creation of the contact.

10. The mobile terminal of claim 9, wherein the one or more programs further include instruction for receiving at least one piece of information inputted by a user prior to generating the contact information, and wherein generating comprises: generating the contact information comprising the information inputted by the user and the obtained environmental information.

11. The mobile terminal of claim 10, wherein the information inputted by the user is selected from a group consisting of a nickname, an introducer, and other descriptive information of the contact.

12. The mobile terminal of claim 9, wherein obtaining comprises at least one of:
obtaining a contact creation time;
obtaining geographical location information of the mobile terminal;
obtaining audio information comprising a voice sample of the contact; and
obtaining image information comprising at least one of photos of the surrounding environment.

13. The mobile terminal of claim 12, wherein the geographical location information comprises at least one map with a pinpoint indicating a current geographical location.

14. The mobile terminal of claim 12, wherein, if the one or more programs include instruction for obtaining the geographical location information, the one or more programs further include instruction for:
obtaining weather information corresponding to an area indicated by the obtained geographical location information.

15. The mobile terminal of claim 14, wherein obtaining the weather information comprises:
determining the area indicated by the obtained geographical location information and obtaining the weather information corresponding to the area with a weather information application; or
determining the area indicated by the obtained geographical location information and obtaining the weather information corresponding to the area by performing a search using name of the area as a keyword.

16. The mobile terminal of claim 12, wherein, if the one or more programs include instruction for obtaining the audio information, the one or more programs further include instruction for:
collecting a voice sample of a contact at opposite end during a communication when receiving a voice recognition command;
recognizing the voice sample of the contact at opposite end according to the obtained voice samples of contacts; and
if the obtained voice samples of the contacts comprise a voice sample matching with the voice sample of the contact at opposite end, obtaining contact information corresponding to the matched voice sample.

17. A nonvolatile computer readable storage medium storing one ore more programs, which when executed perform a method in a mobile terminal, the method comprising:
receiving a request for creating the contact;
obtaining at least one piece of environmental information; and
generating contact information of the contact comprising the obtained environmental information,
wherein the environmental information is configured to identify environment during the creation of the contact.

18. The nonvolatile computer readable storage medium of claim 17, wherein the method further comprises: receiving at least one piece of information inputted by a user prior to generating the contact information, and wherein generating comprises: generating the contact information comprising the information inputted by the user and the obtained environmental information.

19. The nonvolatile computer readable storage medium of claim 18, wherein the information inputted by the user is selected from a group consisting of a nickname, an introducer, and other descriptive information of the contact.

20. The nonvolatile computer readable storage medium of claim 17, wherein obtaining comprises at least one of:
obtaining a contact creation time;
obtaining geographical location information of the mobile terminal;
obtaining audio information comprising a voice sample of the contact; and
obtaining image information comprising at least one of photos of the surrounding environment.
